(19) United States
(12) Patent Application Publication
(10) Pub. No.: US 2006/0239507 A1
(43) Pub. Date: Oct. 26, 2006

(54) Method for determining the lateral offset of an XYZ stage

(75) Inventor: Rene Schenck, Jena (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems CMS GmbH, Wetzlar (DE)

(21) Appl. No.: 11/408,225

(22) Filed: Apr. 20, 2006

(30) Foreign Application Priority Data
Apr. 22, 2005 (DE) 10 2005 018 896.6

(51) Int. Cl. G06K 9/00; H04N 7/18; H04N 5/225; G06K 9/36

(52) U.S. Cl. 382/103; 382/291; 382/151; 348/143; 348/169

(57) ABSTRACT

A method for determining the lateral offset of an XYZ stage includes, by shifting the XYZ stage in the Z direction, acquiring a series of images. In the last image acquired in the series of individual images, a feature of interest is searched for and is positioned at the center of the microscope's image field. Proceeding from the reference image, the lateral offset in the X direction and Y direction is then ascertained for each further image.

### CROSS REFERENCE TO RELATED APPLICATIONS

This application claims priority to German patent application 10 2005 018 896.6, the entire subject matter of which is hereby incorporated by reference herein.

### FIELD OF THE INVENTION

The invention relates to a method for determining the lateral offset of an XYZ stage.

### BACKGROUND OF THE INVENTION

US publication US 2002/0104231 discloses an apparatus for determining the position of an XY stage. The XY stage carries a wafer on which several features are constituted. The image of a feature is acquired with a TV camera, and adjusted for optimum sharpness using the Z drive. The image processing unit acquires the position of the feature and transfers it to a computer in order to store that position. In a subsequent step, the XY stage is shifted to a different position and the same feature is once again searched for and imaged. The computer ascertains a possible rotation of the feature. The rotation of the feature is determined for the X direction and the Y direction. A laser interferometer determines the present position of the XY stage and, in combination with the computer, outputs a corresponding control signal to the XY stage, so that any rotation of the feature on the wafer is compensated for by the displacement of the XY stage.

FIG. 2 shows a prior art assemblage with which the lateral offset of the XYZ stage can be determined. An external test assemblage 10 was used to determine the lateral offset of the XYZ stage. “External test assemblage” means in this context that the XYZ stages were selected prior to installation in the actual system or the actual measurement apparatus. Only those stages that met specific selection criteria were then inserted into the system or the inspection apparatus for the disk-shaped objects, and used for further measurements with the system or the inspection apparatus. External test assemblage 10 possesses a first measurement probe 11 and a second measurement probe 12 for determining the offset in the X direction. External test assemblage 10 likewise possesses a first measurement probe 13 and a second measurement probe 14 for measuring the offset in the Y direction. XYZ stage 15 can be displaced by means of a Z drive 16 in the direction of an optical axis. The lateral offset of the stage in the X direction and Y direction is then determined by way of probes 11, 12, 13, and 14. A stage that exhibits a limit value of <150 nm for the lateral offset is identified as a “good” stage and can thus be built into the apparatus for micro-inspection. A problem here is that because the mounting conditions of the XYZ stage in the inspection apparatus are different, the XYZ stage behaves differently than in test assemblage 10. In addition, therefore, the microscopic image is visually evaluated. Attempts to measure the image on a display objective (e.g. using templates or rules) were unsuccessful. An evaluation of dynamic processes (e.g. oscillation decay after positioning), which is likewise important, is not possible.

### SUMMARY OF THE INVENTION

It is an object of the present invention to provide a method with which the lateral offset of an XYZ stage can be determined directly in the installed state in a measurement apparatus in which it is to be used.

The present invention provides a method for determining the lateral offset of an XYZ stage, where, for example after installation of the XYZ stage in a system for examining disk-shaped objects, the XYZ stage is shifted in the Z direction; and that in that context a series of several individual images is acquired. The last image acquired in the series of several individual images is used as a reference, a characteristic feature being searched for in the acquired image and its center being localized. This characteristic feature is then searched for in every further image of the series of several individual images, and the offset of the characteristic feature in the X direction and the Y direction is determined. The offset is ascertained in comparison with the last image acquired in the series of several individual images. Lastly, the offset of the characteristic feature in the X direction and Y direction ascertained for each acquired image of the series of several individual images is stored.

Acquisition of the series of several individual images is achieved by imaging a focus traverse using video. The video is broken down into a series of individual images.

The characteristic feature is searched for in the last acquired image using an image processing function. In the context of determining the offset of the characteristic feature in the X direction and Y direction by comparison with the last image acquired in the series of several individual images, the values of the offset exist as a multiple of pixels. Beginning with the last image acquired, for each of the acquired images in the series of several individual images, an image index and the ascertained offset of the characteristic feature in the X direction and the Y direction are stored. In the case of unsharp features, the image index is merely incremented and stored. Storage of the offset of the characteristic feature in the X direction and Y direction does not occur.

The data, comprising the image index, name of the image file, offset of the characteristic feature in the X direction, and offset of the characteristic feature in the Y direction, are stored in a table. In a measurement program utilized by a user, the table is loaded into a table calculation program, and the largest offset occurring in the acquired sequence of individual images in the X direction and the Y direction is displayed to the user.

The offset of the acquired sequence of individual images in the X direction and the Y direction is visualized in an XY diagram.

### BRIEF DESCRIPTION OF THE DRAWINGS

The drawings schematically depict the subject matter of the invention and are described with reference to the Figures below, in which:

FIG. 1 schematically depicts a system for inspecting a disk-shaped object;

FIG. 2 shows an assemblage according to the prior art for determining the lateral offset of the stage;

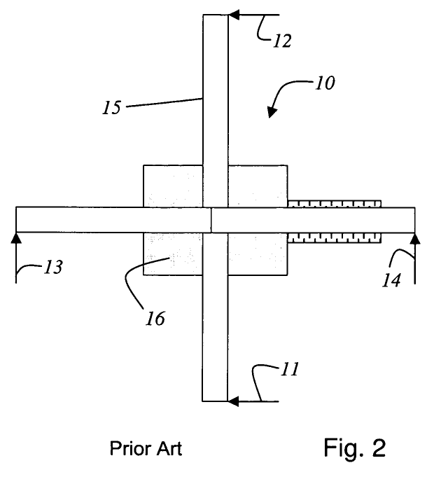

FIG. 3 schematically depicts an assemblage for ascertaining the lateral offset of an XYZ stage in a system for inspecting disk-shaped substrates; and

FIG. 4 graphically depicts the lateral offset of an XYZ stage such as the one installed in a system for inspecting disk-shaped substrates.

### DETAILED DESCRIPTION OF THE INVENTION

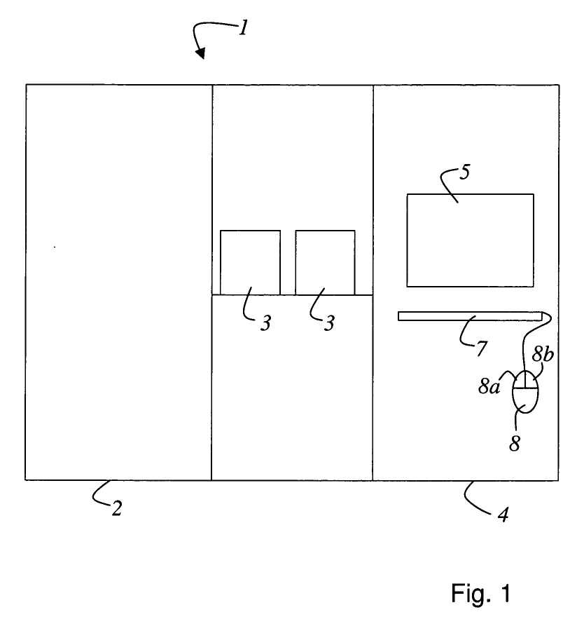

FIG. 1 shows a system 1 for examining disk-shaped objects. System 1 can be made up of several modules 2 or 4, which can be assembled in accordance with the user's stipulations and the user's inspection desires. For example, system 1 can encompass a module 2 for macro-inspection. System 1 can likewise additionally comprise a module 4 for micro-inspection of disk-shaped objects. The disk-shaped objects are brought to system 1 using at least one container 3. System 1 encompasses a display 5 on which various user interfaces can be presented. Also associated with system 1 is a keyboard 7 with which the user can make inputs, in order thereby to modify the control system of system 1 in desired fashion. Keyboard 7 can moreover have associated with it a further input unit 8 with which the user can make inputs, or with which the user can control a cursor on display 5. Input unit 8 encompasses a first input element 8a and a second input element 8b. In a preferred embodiment, input unit 8 is embodied as a mouse. If system 1 for the examination of disk-shaped objects is made up of a module 2 for micro-inspection, the lateral offset of the XYZ stage can be presented on display 5. For that purpose, the XYZ stage is built into system 1 or into module 2 and its offset is ascertained using a plurality of acquired individual images.

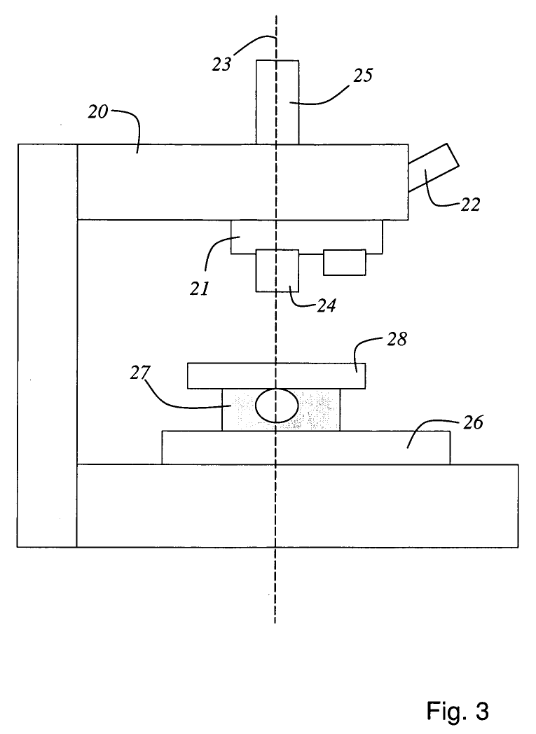

FIG. 3 is a schematic view of the apparatus with which the method according to the present invention for determining the lateral offset of an XYZ stage is carried out. System 1 for micro-inspection encompasses a microscope 20 with which micro-inspection of a disk-shaped substrate can be carried out. The disk-shaped object is deposited onto a holder 28 that is placed on an XYZ stage 26. XYZ stage 26 encompasses a Z drive 27 with which holder 28 can be displaced in the direction of an optical axis 23 of microscope 20. The microscope furthermore possesses an eyepiece 22 through which the user can perform a direct visual observation of the disk-shaped object. Associated with microscope 20 is a camera 25 that is likewise mounted in the optical axis of the microscope. Several objectives 24, which can be introduced into optical axis 23 in accordance with the user's desire for magnification, are mounted on a revolving turret 21. Objective 24 images a portion of interest of the surface of the disk-shaped object. This image is acquired by camera 25 and can also be presented to the user on display 5 of the system. In order to determine the lateral offset of XYZ stage 26, XYZ stage 26 or holder 28 is shifted in the direction of optical axis 23. During shifting, a series of individual images is acquired by camera 25. The last of the series of acquired individual images is used as a reference. In the reference image, a characteristic feature is searched for and its center is localized. Localization of the center can be carried out with an image processing program. It is likewise possible for the user to localize the center manually on the image of the feature on display 5. In addition, in each of the entire series of acquired individual images, the characteristic feature is localized and its offset in the X direction and the Y direction is determined. For each acquired image of the series, the offset in the X direction and the Y direction ascertained for it is stored. As the offset is ascertained, between the individual images of the acquired series the image index is incremented by one from one examined image to the next. If the characteristic feature cannot be found in an image, or if the characteristic feature cannot be evaluated because of insufficient focus, the image index is simply incremented without ascertaining the offset in the X direction and the Y direction.

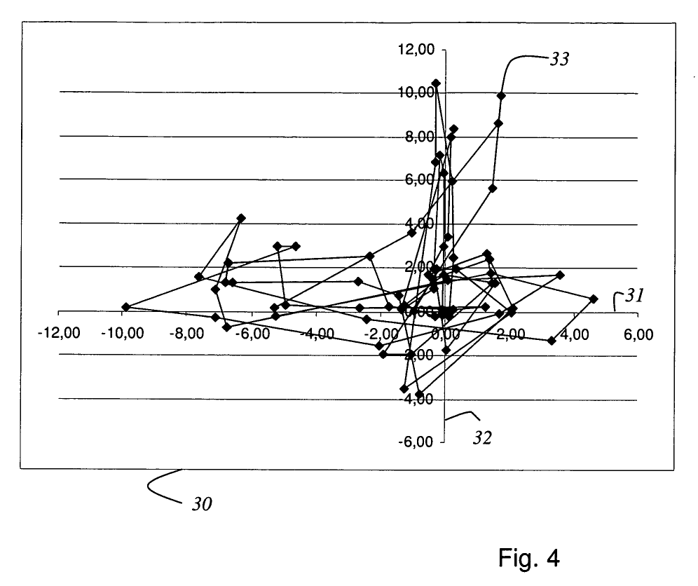

FIG. 4 shows a diagram 30 that graphically depicts the offset of XYZ stage 26 for the individual images of the acquired series of individual images. The offset in the X direction is depicted on abscissa 31, and the offset in the Y direction on ordinate 32. Each measurement point 33 depicted in diagram 30 represents the offset of a characteristic feature in the X direction and Y direction for a specific position of the XYZ stage in the Z direction (direction of the optical axis). The data obtained from the series of acquired individual images are entered into a table and stored. The stored data encompass the image index, an image file name, the offset of the characteristic feature in the X direction, and the offset of the characteristic feature in the Y direction. Each image index therefore has assigned to it a position of XYZ stage 26 in the Z direction. When the user then utilizes a specific measurement program, he or she can retrieve the table and thus perform, as a function of the position of XYZ stage 26, a corresponding correction of the measured X and Y coordinates of a specific feature. The correction is ascertained, for a specific image index, on the basis of the data stored in the table for the offset in the X direction and the Y direction.

What is claimed is:

1. A method for determining the lateral offset of an XYZ stage, the method comprising:
shifting the XYZ stage in a Z direction and acquiring a first and then a second image during the shifting;
searching for a characteristic feature in the second image and localizing a center of the characteristic feature;
localizing the characteristic feature in the first image and determining a first X offset of the characteristic feature in an X direction and a first Y offset of the characteristic feature in a Y direction based on a comparison with the second image; and
storing the first X and Y offsets.

2. The method as recited in claim 1 wherein the acquiring the first and second images is performed by imaging a focus traverse using video.

3. The method as recited in claim 2 wherein the acquiring includes breaking down the video into a series of individual images.

4. The method as recited in claim 1 wherein the searching is performed using an image processing function.

5. The method as recited in claim 1 wherein the offset includes a multiple of pixels.

6. The method as recited in claim 1 further comprising storing a first image index associated with the first image.

7. The method as recited in claim 6 further comprising:
acquiring a third image during the shifting prior to the acquiring the second image;
attempting to localize the characteristic feature in the third image; and
when the characteristic feature in the third image is unsharp, storing a third image index associated with the third image.

8. The method as recited in claim 6 wherein the storing the first image index and the storing the first X and Y offsets are performed so as to store the first image index and the first X and Y offsets offset in a table, and further comprising storing, in the table, a name of a file of the first image.

9. The method as recited in claim 1 further comprising:
acquiring a third image during the shifting prior to the acquiring the second image;
localizing the characteristic feature in the third image and determining a third X offset of the characteristic feature in the X direction and a third Y offset of the characteristic feature in a Y direction based on a comparison with the second image; and
storing the third X offset and the third Y offset.

10. The method as recited in claim 9 further comprising storing a first image index associated with the first image and third image index associated with the third image.

11. The method as recited in claim 10 wherein the storing the first and third image indexes and the storing the first and third X and Y offsets are performed so as to store the first and third image indexes and the first and third X and Y offsets in a table, and further comprising storing, in the table, a name of a first file of the first image and a third file of the third image.

12. The method as recited in claim 11 further comprising:
loading, in a measurement program utilized by a user, the table into a table calculation program; and
displaying to the user the largest respective X and Y offsets of the first and third X and Y offsets.

13. The method as recited in claim 9 further comprising providing the first and third X and Y offsets in an XY diagram so as to enable a motion process of the XYZ stage to be visualized.
